(19) United States
(12) Patent Application Publication
(10) Pub. No.: US 2025/0164081 A1
(43) Pub. Date: May 22, 2025

(54) IoT-BASED GAS SAFETY SHUTOFF SYSTEM

(71) Applicant: SAFETEC CO., LTD., Bucheon-si (KR)

(72) Inventors: In Kyu KIM, Bucheon-si (KR); Kang Min LEE, Bucheon-si (KR)

(21) Appl. No.: 17/619,716

(22) PCT Filed: Dec. 2, 2021
(86) PCT No.: PCT/KR2021/018100

§ 371 Date: Dec. 16, 2021

(51) Int. Cl. F17D 5/00; F17D 5/02

(52) U.S. Cl. CPC F17D 5/005; F17D 5/02

(57) ABSTRACT

Disclosed is an IoT-based gas safety shutoff system including: a shutoff unit installed between a pipe connected from a gas supply source located outdoors and disposed indoors and an indoor gas hose connector connected to a cooking utensil, and including a shutoff valve configured to be opened and closed so that gas is introduced from the gas supply source to the cooking utensil or inflow of the gas is blocked; and a control unit electrically connected with the shutoff unit to open and close the shutoff unit under a predetermined condition.

### TECHNICAL FIELD

The present invention relates to an Internet of Things (IoT)-based gas safety shutoff system, and more particularly, to an IoT-based gas safety shutoff system which prevents fire caused by leaving during cooking, electrical factors, malfunctions, and the like, and ensures the safety of the silver generation.

### BACKGROUND ART

In the United States, 65 million households out of 330 million people and 128 million households use LNG for cooking and heating, due to the over 100-year history of gas use, there is a risk of a major accident due to gas leakage from old pipes and the installation of gas safety devices in the kitchen has not been legislated, so that more than 170,000 fires occur annually due to various factors, such as 50% leaving during cooking, 20% electrical factors, and other factors (erroneous operation of an overheating preventing device), such as cooking utensils (microwave oven, oven, gas stove, etc.), and accordingly, the need and interest in safety of the silver generation with purchasing power is very high.

To summarize the functions and features of a safety device for cooking utensils in the United States to solve such a problem in the related art, a method of shutting off the power of a cooking device by being connected to the cooking device or locking an operation button of the cooking device is used.

In particular, the low-cost type is a plug type equipped with a timer, the low-end type is a plug type with a built-in smoke detector, and the high-end type is a timer connected with a motion sensor, which are mostly for electric stoves, and the product that controls the gas stove is the highest price ($575) product in which a motion sensor and a timer are connected to a Wi-Fi network, but there is a problem in that it is impossible to prevent large-scale fire accidents including explosions due to gas leakage because there is no gas leak detection function.

Further, as illustrated in FIG. 1, in the gas supply system currently used in the United States, an outside pipe P2 is connected to a gas supply source (storage tank) located outside the building, and the outside pipe P2 is connected to an inside pipe P1 located inside the building.

In addition, since an indoor gas hose connector PAC connected to a cooking utensil PA is connected to the inside pipe P1, the cooking utensil PC and the inside pipe P1 may be connected to each other.

In this case, the indoor gas hose connector PAC should not be hidden and should not extend from one room to another room, or pass through a wall partition, ceiling or floor, and an individual shutoff valve (appliance shutoff valve) 1 is connected between the indoor gas hose connector PAC and the inside pipe P1.

As for the generally used individual shutoff valve 1, a manual ball valve is mainly used, and in particular, depending on the purpose, any one of a low-pressure ball valve or a ball valve for a higher-pressure (5G (34 kPa)) mainly used for a gas pipe may be used.

The individual shutoff valve 1 in the related art has a problem in that user's accessibility is low during maintenance and repair due to the regulations that the individual shutoff valve 1 must be within 6 feet (1,829 mm) of the cooking utensil and be located inside or under the cooking utensil to be accessible as illustrated in FIG. 2.

Accordingly, due to the problems of the manual structure and the accessibility of the individual shutoff valve 1 described above, the cooking utensil is used while the individual shutoff valve 1 is always opened in general homes.

Accordingly, in fact, the shutoff function of the individual shutoff valve 1 is meaningless, and accordingly, when gas is leaked, there is a high possibility that it will lead to a large-scale fire accident including explosion and the like.

In the meantime, since the installation standards for fire alarm systems in the United States regulate that the fire alarm system is installed in accordance with National Fire Alarm and Signaling Code (NFPA) 72 when installing fire alarm systems in the US Building Act (IBC), it can be said that the standard of NFPA 72 is followed throughout the United States, and even in the case of a smoke detector, installation is mandatory in all residential facilities for households in accordance with NFPA 72.

However, the existing fire alarm equipment including the smoke detector is not interlocked with the above-described individual shutoff valve 1, but has only the sensing and alarm functions, so that there is a problem in that a user cannot block the gas leakage in special situations in which the alarm cannot be recognized (for example, in the case where the user is a hearing or visually impaired person (disabled person), an elderly person with dementia or a child, or the user leaves while cooking).

### DISCLOSURE

### Technical Problem

The present invention has been made in an effort to solve the problems in the related art, and provides an IoT-based gas safety shutoff system including: a shutoff unit installed between a pipe connected from a gas supply source located outdoors and disposed indoors and an indoor gas hose connector connected to a cooking utensil, and including a shutoff valve configured to be opened and closed so that gas is introduced from the gas supply source to the cooking utensil or inflow of the gas is blocked; and a control unit electrically connected with the shutoff unit to open and close the shutoff unit under a predetermined condition.

The technical objects of the present disclosure are not limited to the foregoing technical objects, and other non-mentioned technical objects will be clearly understood by those skilled in the art from the description below.

### Technical Solution

An exemplary embodiment of the present invention provides an IoT-based gas safety shutoff system including: a shutoff unit installed between a pipe connected from a gas supply source located outdoors and disposed indoors and an indoor gas hose connector connected to a cooking utensil, and including a shutoff valve configured to be opened and closed so that gas is introduced from the gas supply source to the cooking utensil or inflow of the gas is blocked; and a control unit electrically connected with the shutoff unit to open and close the shutoff unit under a predetermined condition.

Further, the IoT-based gas safety shutoff system according to the exemplary embodiment of the present invention may further include a time setting unit which is connected to the control unit and closes the shutoff unit when a predetermined time elapses from an operation time of the cooking utensil.

In addition, the IoT-based gas safety shutoff system according to the exemplary embodiment of the present invention may further include a detecting unit which is connected to the control unit, and detects environment information corresponding to the predetermined condition and transmits the detected environment information to the control unit.

In this case, the detecting unit may include a flow rate sensor which checks a flow of the gas introduced to the cooking utensil.

In the case where the shutoff valve is in an on state in an initial state in which the cooking utensil is not used, when a flow rate is sensed through the flow rate sensor in the state where the cooking utensil is in an off state by a user, the control unit may turn off the shutoff valve.

In the meantime, in the case where the shutoff valve is in an off state in an initial state in which the cooking utensil is not used, when a predetermined time elapses in the state where the cooking utensil is operated by a user, the control unit may turn off the shutoff valve again regardless of the sensing by the flow rate sensor.

Further, the detecting unit may include a motion detecting sensor which detects presence/absence of movement of an object at one area of the cooking utensil and transmits a result of the detection to the control unit.

In the case where the shutoff valve is in an on state in an initial state where the cooking utensil is not used, when a movement is detected at one area of the cooking utensil when a flow rate is sensed at a termination time of the operation of the cooking utensil after the cooking utensil is operated and then a predetermined time elapses, the control unit may maintain the shutoff valve in the on state for a predetermined time and then turn off the shutoff valve.

When a movement is not sensed for a first time from an operation time of the cooking utensil by monitoring the movement at the one area of the cooking utensil, the control unit may change a second time at which the operation of the cooking utensil is terminated by the time setting unit to the first time that is shorter than the second time.

The detecting unit may include a gas leakage detecting sensor which checks leakage of gas in a space in which the cooking utensil is placed.

When the leakage of the gas in the space in which the cooking utensil is placed is confirmed, the control unit may turn off the shutoff valve regardless of the operation state or the non-operation state of the cooking utensil.

The detecting unit may include a vibration detecting sensor which detects vibration of the cooking utensil.

When a vibration value of the cooking utensil exceeds a predetermined value, the control unit may turn off the shutoff valve regardless of the operation state or the non-operation state of the cooking utensil.

The detecting unit may include a smoke leakage detecting sensor which detects a fire in a space in which the cooking utensil is placed.

When the smoke is detected in the space in which the cooking utensil is placed, the control unit may turn off the shutoff valve regardless of the operation state or the non-operation state of the cooking utensil.

Further, the IoT-based gas safety shutoff system according to the exemplary embodiment of the present invention may further include a communication unit connected to at least one of the shutoff unit, the control unit, and the detecting unit so as to transmit information of at least one of the shutoff unit, the control unit, and the detecting unit to the outside.

Herein, the communication unit may be mounted to an external IoT router and provided so that any one of the shutoff unit, the control unit, and the detecting unit interworks with an external device.

Further, the communication unit may be integrally provided with an IoT router so that an IoT external device is connected and interworks with at least one of the shutoff unit, the control unit, and the detecting unit.

In addition, the IoT-based gas safety shutoff system according to the exemplary embodiment of the present invention may further include a warning unit configured to receive an alarm generation request generated from the control unit and generates an alarm.

The warning unit may be connected with the communication unit, and generate the generated alarm as at least one of voice information and image information, and simultaneously generate olfactory information, and may include a fragrance generating module which sprays fragrance to a predetermined space for visual and hearing-impaired people.

### Advantageous Effects

The IoT-based gas safety shutoff system of the present invention has the following effects.

First, the IoT-based gas safety shutoff system of the present invention automatically blocks or releases the block of gas supplied to a cooking utensil from a gas supply source under a predetermined condition, so that it is possible to prevent large-scale fire accidents including gas leakage, explosion, and the like that may occur due to the use of the cooking utensil with the valve always open due to the problem in the manual structure and accessibility in the relate art and for the convenience for the user.

Second, the IoT-based gas safety shutoff system of the present invention is provided to interwork with a detection device including existing fire warning equipment, such as a smoke detector, and IoT terminal devices, so that it is possible to safely shut off gas even when users with hearing or visual impairments (disabled person), elderly people with dementia, and children use the cooking utensil or when the user forgets the operation of the cooking utensil and goes out.

The effects of the present invention are not limited to the foregoing effects, and other non-mentioned effects will be clearly understood by those skilled in the art from the description below.

### BRIEF DESCRIPTION OF THE DRAWINGS

The summary set forth above as well as the detailed description of the exemplary embodiments of the present application to be described below may be better understood when read in conjunction with the accompanying drawings. The exemplary embodiments are illustrated in the drawings for the purpose of illustrating the present invention. However, it should be understood that the present application is not limited to the illustrated accurate disposition and means.

FIG. 1 is a diagram illustrating a gas supply system in the related art.

FIG. 2 is a diagram for describing an access issue of an individual shutoff valve (applicant shutoff valve) in the related art.

FIG. 3 is a diagram illustrating an Internet of Things (IoT)-based gas safety shutoff system according to an exemplary embodiment of the present invention.

FIG. 4 is a diagram illustrating an IoT-based gas safety shutoff system further including a detecting unit according to another exemplary embodiment of the present invention.

FIG. 5 is a diagram illustrating an IoT-based gas safety shutoff system further including a detecting unit and a communication unit according to another exemplary embodiment of the present invention.

FIG. 6 is a diagram illustrating an IoT-based gas safety shutoff system further including a detecting unit, a communication unit, and a warning unit according to an additional exemplary embodiment of the present invention.

### MODE FOR INVENTION

Hereinafter, an exemplary embodiment of the present invention in which the object of the present invention may be specifically realized will be described with reference to the accompanying drawings. In describing the present exemplary embodiment, the names and the same reference numerals are used for the same configurations, and an additional description thereof will be omitted.

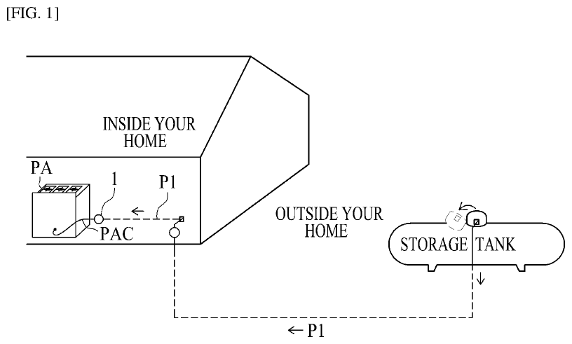

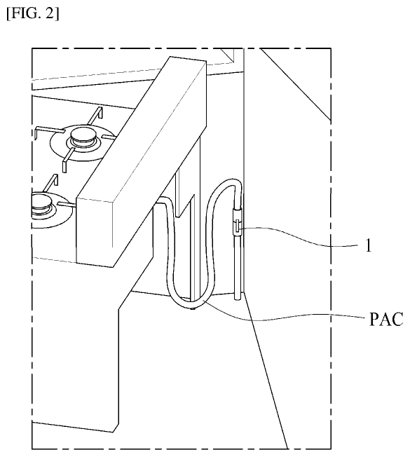

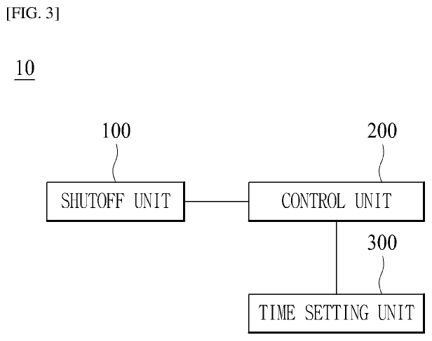

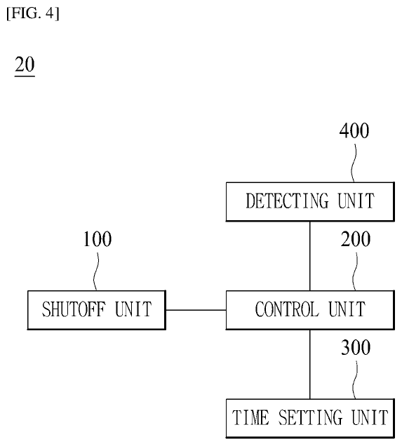

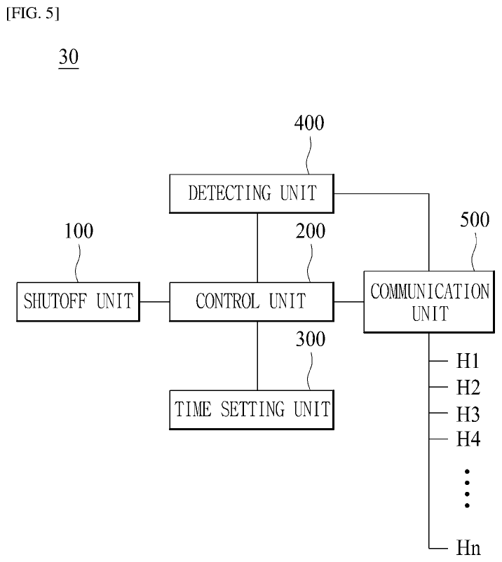

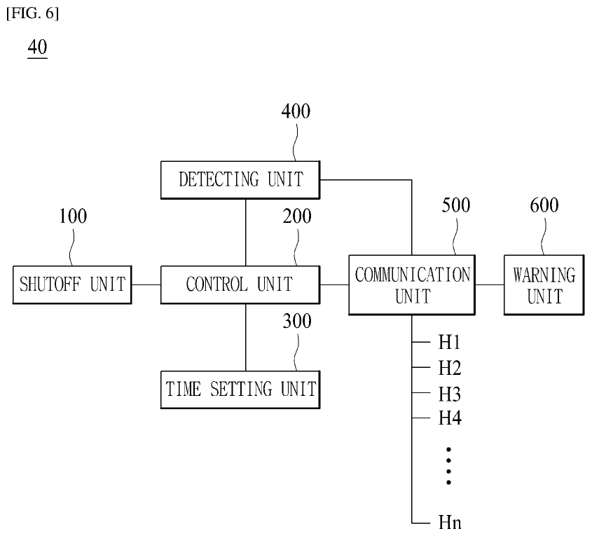

FIG. 1 is a diagram illustrating a gas supply system in the related art, FIG. 2 is a diagram for describing an access issue of an individual shutoff valve (applicant shutoff valve) in the related art, FIG. 3 is a diagram illustrating an Internet of Things (IoT)-based gas safety shutoff system 10 according to an exemplary embodiment of the present invention, FIG. 4 is a diagram illustrating an IoT-based gas safety shutoff system 20 further including a detecting unit 400 according to another exemplary embodiment of the present invention, FIG. 5 is a diagram illustrating an IoT-based gas safety shutoff system 30 further including a detecting unit 400 and a communication unit 500 according to another exemplary embodiment of the present invention, and FIG. 6 is a diagram illustrating an IoT-based gas safety shutoff system 40 further including a detecting unit 400, a communication unit 500, and a warning unit according to an additional exemplary embodiment of the present invention.

As illustrated in FIG. 3, the IoT-based gas safety shutoff system 10 according to the exemplary embodiment of the present invention may generally include a shutoff unit 100 and a control unit 200.

As described above, an outside pipe P2 may be connected to a gas supply source (storage tank) located outside a building and be connected to an inside pipe P1 located inside the building, and an indoor gas hose connector PAC connected to a cooling utensil PA is connected to the inside pipe P1, so that the cooking utensil PC and the inside pipe P1 may be connected with each other.

In this case, the shutoff unit 100 may be provided between the indoor gas hose connector PAC and the inside pipe P1.

That is, the shutoff unit 100 may be installed between a pipe which is connected from the gas supply source located outside the building and is installed inside the building and the indoor gas hose connector PAC connected to the cooking utensil, and may include a shutoff valve which may be opened/closed so that gas is introduced from the gas supply source to the cooking utensil or the inflow of the gas is blocked by the control unit 200.

Herein, the shutoff valve may open/close a flow path by vertically moving a blocking unit (poppet type), and depending on the case, even though the shutoff valve is changed to the manner in which a direction of a fluid is changed by rotating the blocking unit provided to rotate on the same axis (spool method), it will be said that the foregoing methods belong to the scope of the present invention.

Next, the control unit 200 may be provided at one side of the shutoff unit 100 so as to be electrically connected with the shutoff unit 100, and may open and close the shutoff unit 100 under a predetermined condition.

In this case, the control unit 200 may be connected with the shutoff unit 100 by wire or wirelessly, and due to this, the scope of the present invention is not limited as a matter of course.

However, the control unit 200 may be connected to the shutoff unit 100 by wire for electrical connection stability.

In the meantime, the predetermined condition will be described in detail with reference to a time setting unit 300 and a detecting unit 400 which will be described below.

As long as the control unit 200 is electrically connected with the shutoff unit 100 to open and close the shutoff unit 100 under the predetermined condition, a shape and a disposition structure of the control unit 200 may be various, and due to this, the scope of the present invention is not limited as a matter of course.

However, for the detailed description, for example, the control unit 200 may include at least one of a control panel and a display panel.

Further, it may be convenient to dispose the control unit 200 at the upper side of the cooking utensil in order for a user to easily set the predetermined condition through the control panel and easily check state information of the control unit 200 at a location adjacent to the cooking utensil or environment information, which is to be described, during cooking.

Further, the control unit 200 may be provided so as to be connected with existing fire warning equipment including a smoke detector that must be essentially installed in a space in which cooking utensils are placed by wire/wireless communication to open/close the shutoff unit 100 at an emergency situation.

The IoT-based gas safety shutoff systems 10, 20, 30, and 40 according to the exemplary embodiments of the present invention including the foregoing configurations may further include the time setting unit 300 which is connected to the control unit 200 and closes the shutoff unit 100 when a predetermined time elapses from the time at which the cooking utensil is operated.

For example, the time setting unit 300 may receive information indicating that the cooking utensil is operated from the control unit 200, and when 20 minutes elapses from the time at which the cooking utensil is operated, the time setting unit 300 requests the time setting unit 300 to close the shutoff unit 100, so that the shutoff unit 100 may be closed and the gas supply to the cooking utensil may be stopped.

That is, when a predetermined time elapses from the operation time of the cooking utensil, the time setting unit 300 may close the shutoff unit 100 through the control unit 200.

In addition, the time setting unit 300 is directly connected even with the shutoff unit 100, so that when the predetermined time elapses, the time setting unit 300 may primarily close the shutoff unit 100 and also finally notify the control unit of the close of the shutoff unit 100.

As illustrated in FIG. 4, an IoT-based gas safety shutoff system 20 according to another exemplary embodiment of the present invention includes a shutoff unit 100, a control unit 200, and a time setting unit 300, and may further include a detecting unit 400.

Herein, the shutoff unit 100, the control unit 200, and the time setting unit 300 are the same as or identical to the shutoff unit 100, the control unit 200, and the time setting unit 300 described above, so that the descriptions thereof will be omitted, and only the different parts will be described.

The detecting unit 400 may detect environment information corresponding to a predetermined condition and transmit the detected environment information to the control unit 200 so that the control unit 200 opens/closes the shutoff unit 100 under a predetermined condition.

The environmental information detected by the detecting unit 400 includes at least one of smoke amount information related to fire in an indoor space in which the cooking utensil is placed, vibration information for earthquake detection, flow rate information about a flow rate supplied to the cooking utensil, and movement information of one area of the cooking utensil.

That is, the detecting unit 400 may include at least one of a flow rate sensor that checks the flow of gas flowing into the cooking utensil, a motion detecting sensor that detects the presence or absence of movement of an object in one area of the cooking utensil and transmits a result of the detection to the control unit 200, a gas leakage detecting sensor that checks the gas leakage in the space where the cooking utensil is placed, a vibration detecting sensor that detects vibration of cooking utensils, and a smoke detecting sensor that detects fire in the space where the cooking utensils are placed.

In this case, the shutoff unit 100 set the shutoff valve to an ON state in an initial state in which the cooking utensil is not used, and conversely may set the shutoff valve to an OFF state in the initial state.

For example, in the case where the shutoff valve is in the ON state in the initial state in which the cooking utensil is not used, when the cooking utensil is in the OFF state by the user and a flow rate is sensed through the flow rate sensor, the control unit 200 may turn off the shutoff valve and maintain the OFF state.

Further, in the case where the shutoff valve is in the OFF state in the initial state in which the cooking utensil is not used, when the cooking utensil is operated by the user by the time setting unit 300 and a predetermined time elapses, the control unit 200 may turn off the shutoff valve again regardless of sensing by the flow rate sensor.

Further, in the case where the detecting unit 400 includes the flow rate sensor and the motion detecting sensor, when the shutoff valve is set in the ON state in the initial state in which the cooking utensil is not used, and when the cooking utensil is operated, a predetermined time elapses, and a flow rate is sensed at the termination time of the operation of the cooking utensil, and a motion is detected at one area of the cooking utensil, the control unit 200 may maintain the shutoff valve in the ON state for a predetermined time (for example, one to three minutes) and then turn off the shutoff valve.

In addition, when the control unit 200 monitors the motion of one area of the cooking utensil and the motion is not sensed for a first time from the operation time of the cooking utensil, the control unit 200 may decrease a second time, that is, the predetermined time, at which the operation of the cooking utensil is terminated by the time setting unit 300, to the first time that is shorter than the second time.

That is, when the flow rate sensor and the motion detecting sensor are included in the detecting unit 400, the control unit 200 may flexibly decrease the timer time preset by the time setting unit 300 by interworking with the information of the flow rate sensor and the motion detecting sensor.

On the other hand, in situations that may lead to large-scale accidents, such as earthquakes, fires, and explosions, the control unit turns off the shutoff valve regardless of whether the cooking utensil is in operation or not in operation when a gas leakage is detected in the space where the cooking utensil is placed.

Further, when a vibration value of the cooking utensil exceeds a predetermined value, the control unit 200 may turn off the shutoff valve regardless of whether the cooking utensil is in operation or not in operation.

In addition, when smoke is detected in the space in which the cooking utensil is placed, the control unit 200 may turn off the shutoff valve regardless of whether the cooking utensil is in operation or not in operation.

Herein, when the gas leakage, the vibration, or the smoke is detected in the case where the shutoff valve is set to the OFF state in the initial state, the control unit may continuously maintain the shutoff valve in the OFF state, and depending on the cases, the control unit may maintain the shutoff valve in the OFF State even though the user operates the cooking utensil so as to prevent the user from operating the cooking utensil without being aware of the above-mentioned risk.

The foregoing predetermined condition will be described in detail one more through the table as follows.

In the case where the shutoff valve included in the shutoff unit 100 is always set to the ON-state and is used in the initial state in which the cooking utensil is not used, the control unit may open/close the shutoff unit 100 under the predetermined condition described in Table 1-1 and Table 1-2 below.

In the case where the shutoff valve in the initial state is ON

TABLE 1-1

| Cooking utensil | Time setting | Whether to sense | |
|---|---|---|---|
| state (normally) | unit | flow rate | Shutoff unit |
| ON | Timer start | ◯ | Maintain shutoff |
| | | | valve ON |
| OFF | Timer reset | X | Maintain shutoff |
| | | | valve ON |
| | | ◯ | Shutoff valve ON |
| | | | → OFF |

When the ON state of the shutoff valve is set as the initial state, and the cooking utensil is turned on, a timer may start by the time setting unit 300.

Further, the gas flow rate supplied by the operation of the cooking utensil is sensed, and the shutoff valve may maintain the ON state.

Further, when the cooking utensil is turned off by the user at a normal time, the timer may be reset by the time setting unit 300, and the gas supply to the cooking utensil is stopped and it is safe, so that the shutoff valve may maintain the ON-state.

Herein, when the cooking utensil is turned off by the user, but the flow rate is detected, the control unit turns off the shutoff valve without maintaining the ON-state to secure safety.

TABLE 1-2

| | | | Whether to | |
|---|---|---|---|---|
| Cooking | Environment | Time setting | sense flow | |
| utensil state | change | unit | rate | Shutoff unit |
| ON | Leave | Timer end | Regardless | Shutoff valve |
| | | | of ◯/X | ON → OFF |
| Regardless | Gas leakage | Regardless | Regardless | Shutoff valve |
| of ON/OFF | | of timer | of ◯/X | ON → OFF |
| | | state | | |
| | Earthquake | Regardless | Regardless | Shutoff valve |
| | detection | of timer | of ◯/X | ON → OFF |
| | | state | | |
| | Fire | Regardless | Regardless | Shutoff valve |
| | occurrence | of timer | of ◯/X | ON → OFF |
| | | state | | |

Further, as represented in Table 1-2, in the case where the ON-state of the shutoff valve is set to the initial state, when the user leaves the place in the state where the cooking utensil in the ON state, the control unit may control the state of the shutoff value from the ON state to the OFF state regardless of sensing the flow rate when a predetermined time elapses.

In addition, when the situation where the gas leaks, the earthquake occurs, or a fire occurs is detected through the detecting unit 400 regardless of the ON/OFF state of the cooking utensil, the control unit may turn off the shutoff valve regardless of the timer progress state of the time setting unit 300 and the sensing of the flow rate.

Next, in the case where the shutoff valve included in the shutoff unit 100 is set to be always in the OFF state in the initial state in which the cooking utensil is not used, the control unit may open/close the shutoff unit 100 under the predetermined conditions represented in Table 2-1 and Table 2-2 below.

In the case where the shutoff valve in the initial state is OFF

TABLE 2-1

| Cooking utensil | Time setting | Whether to sense | |
|---|---|---|---|
| state (normally) | unit | flow rate | Shutoff unit |
| ON | Timer start | ◯ | Shutoff valve OFF |
| | | | → ON |
| OFF | Timer reset | Regardless of | Shutoff valve ON |
| | | ◯/X | → OFF |

In the case where the OFF state of the shutoff valve is set as the initial state, when the cooking utensil is turned on by the user, the timer may be started by the time setting unit 300.

In this case, the gas flow rate supplied by the operation of the cooking utensil is sensed, and the state of the shutoff valve may be changed from the OFF state to the ON state by the control unit.

Further, when the cooking utensil is turned off by the user at a normal time, the timer may be reset by the time setting unit 300, and the state of the shutoff valve may be changed from the ON state to the OFF state by the control unit regardless of sensing the flow rate.

In more particular, when the cooking utensil is turned off by the user, the state of the shutoff valve is changed from the ON state to the OFF state by the control unit, so that it is possible to prevent the situation where gas is supplied from the cooking utensil in the OFF state of the cooking utensil.

TABLE 2-2

| Cooking | | | Whether to | |
|---|---|---|---|---|
| utensil | Environment | Time setting | sense flow | |
| state | change | unit | rate | Shutoff unit |
| ON | Leave | Timer end | Regardless of | Shutoff valve |
| | | | ◯/X | ON → OFF |
| ON | Gas leakage | Regardless | Regardless of | Shutoff valve |
| | | of timer | ◯/X | ON → OFF |
| | | state | | |
| | Earthquake | Regardless | Regardless of | Shutoff valve |
| | detection | of timer | ◯/X | ON → OFF |
| | | state | | |
| | Fire | Regardless | Regardless of | Shutoff valve |
| | occurrence | of timer | ◯/X | ON → OFF |
| | | state | | |
| OFF | Gas leakage | — | Regardless of | Maintain |
| | | | ◯/X | shutoff valve |
| | | | | OFF |
| | Earthquake | — | Regardless of | Maintain |
| | detection | | ◯/X | shutoff valve |
| | | | | OFF |
| | Fire | — | Regardless of | Maintain |
| | occurrence | | ◯/X | shutoff valve |
| | | | | OFF |

Further, similar to the description in Table 1-2, in the case where the OFF state of the shutoff valve is set as the initial state, when the user leaves the place in the state where the cooking utensil in the ON state, the control unit may control the state of the shutoff value from the ON state to the OFF state regardless of sensing the flow rate when a predetermined time elapses.

In addition, when the situation where the gas leaks, the earthquake occurs, or a fire occurs is detected through the detecting unit 400 in the situation where the user turns on the cooking utensil, the control unit may turn off the shutoff valve regardless of the timer progress state of the time setting unit 300 and the sensing of the flow rate.

Further, when the situation where the gas leaks, the earthquake occurs, or a fire occurs is detected through the detecting unit 400 in the situation where the user turns on the cooking utensil, the initial state is the OFF state, so that it is possible to prevent a large-scale accident.

As illustrated in FIG. 5, an IoT-based gas safety shutoff system 30 according to another exemplary embodiment of the present invention includes a shutoff unit 100, a control unit 200, and a time setting unit 300, and a detecting unit 400, and may further include a communication unit 500 connected with at least one of the shutoff unit 100, the control unit 200, and the detecting unit 400 so as to transfer information of at least one of the shutoff unit 100, the control unit 200, and the detecting unit 400 to the outside.

Herein, the shutoff unit 100, the control unit 200, the time setting unit 300, and the detecting unit 400 have been described, so that the detailed description thereof will be omitted, and only the different parts will be described.

The communication unit 500 may be provided to be mountable to an external IoT router in the home.

In this case, the communication unit 500 may be provided so that at least one of the shutoff unit 100, the control unit 200, and the detecting unit 400 interworks with an external device.

For example, when it is assumed that only the communication unit 500 and the control unit 200 are connected through wire/wireless communication, the control unit 200 may receive current state information and a interworking request command from the shutoff unit 100 and the detecting unit 400 and transmits the received current state information and interworking request command to the communication unit 500, and the communication unit 500 may transmit the current state information and the interworking request command to the external IoT router located in the home through wire/wireless communication and the external device connected with the external IoT router may be interworked with the control unit 200.

Further, the communication unit 500 may be provided to directly interwork the shutoff unit 100 and the detecting unit 400 to the external IoT router through the wire/wireless communication interwork.

In addition, the communication unit 500 is integrally provided with the IoT router, so that an IoT external device may interwork with at least one of the shutoff unit 100, the control unit 200, and the detecting unit 400.

That is, a module to which home care devices are connectable is embedded in the communication unit 500, a connection port may be provided at one external side of the communication unit 500, and a communication module that enables wire/wireless communication may be provided.

That is, the present invention includes the communication unit 500, and is connected to a user terminal through wire/wireless communication, such as Bluetooth and WiFi, so that the user is capable of blocking the shutoff valve by remote control with an application or check the indoor situation.

As illustrated in FIG. 6, an IoT-based gas safety shutoff system 40 according to another exemplary embodiment of the present invention includes a shutoff unit 100, a control unit 200, and a time setting unit 300, a detecting unit 400, and a communication unit 500, and may further include a warning unit 600 which receives an alarm generation request generated from the control unit 200 and generates an alarm.

Herein, the shutoff unit 100, the control unit 200, the time setting unit 300, the detecting unit 400, and the communication unit 500 have been described, so that the detailed description thereof will be omitted, and the warning unit 600 will be mainly described.

For example, the warning unit 600 may be connected with the communication unit 500 connected with the control unit 200.

First, when the control unit 200 determines the emergency situation, such as gas leakage, earthquake, and fire, through the detecting units 400, the control unit 200 may transmit an alarm generation request to the warning unit 600 through the communication unit 500.

In this case, the warning unit 600 may inform the user including the visual and hearing-impaired person of the danger through fragrance at the same time as transmitting the generated alarm as voice information.

In this case, the voice information may be generated alternatively with a message voice and an alarm sound indicating the emergency situation.

In addition, the warning unit 600 may inform the user including the visual and hearing-impaired person of the danger through the fragrance at the same time as transmitting the generated alarm as image information.

For example, in the emergency situation, the warning unit 600 transmits a message image and a frame image varying n times per second informing of the emergency situation to the display module provided in the control unit 200, and may be provided at one side of the cooking utensil so as for the user to easily recognize the emergency situation.

In addition, the warning unit 600 may generate at least one of the voice information and the image information as described above, and may also generate olfactory information at the same time.

In this case, the warning unit 600 may include a fragrance generating module, and may spray fragrance into a predetermined space for the visual and hearing-impaired person.

For example, when the warning unit 600 receives the alarm generation request, the warning unit 600 transmits the voice information or the image information to enable the user for easily recognize the emergency situation of the cooking utensil by at least one of the visual sense or the auditory sense, and sprays fragrance through the separate fragrance generating module to enable the user to easily recognize the emergency situation by the olfactory sense.

Further, the fragrance generating module may also be provided to enable the user to rapidly recognize the emergency situation by increasing the number of times of the user's nose is stimulated by setting the amount of fragrance sprayed to be varied for each of a plurality of preset cycles or the amount of fragrance sprayed to increase over time.

Accordingly, the IoT-based gas safety shutoff system of the present invention automatically blocks or releases the block of the gas supplied to the cooking utensil from the gas supply source under the predetermined condition, so that it is possible to prevent large-scale fire accidents including gas leakage, explosion, and the like that may occur due to the use of the cooking utensil with the valve always open due to the problem in the manual structure and accessibility in the relate art.

Further, the IoT-based gas safety shutoff system of the present invention is provided to interwork with the detection device including the existing fire warning equipment, such as a smoke detector, and IoT terminal devices, so that it is possible to safely shut off gas even when users with hearing or visual impairments (disabled person), elderly people with dementia, and children use the cooking utensil or when the user forgets the operation of the cooking utensil and goes out.

In the foregoing, the exemplary embodiment according to the present invention has been described, and in addition to the above-described exemplary embodiment, the fact that the present invention can be embodied in other specific forms without departing from the spirit or the scope of the present invention is apparent to those skilled in the art. Accordingly, the foregoing exemplary embodiment is to be regarded as illustrative, rather than restrictive, and accordingly, the present invention is not limited to the above description and may be changed within the scope of the appended claims and their equivalents.
10,20,30,40: IoT-based gas safety shutoff system
100: shutoff unit
200: control unit
300: time setting unit
400: detecting unit
500: communication unit
600: warning unit

1. An IoT-based gas safety shutoff system, comprising:
a shutoff unit installed between a pipe connected from a gas supply source located outdoors and disposed indoors and an indoor gas hose connector connected to a cooking utensil, and including a shutoff valve configured to be opened and closed so that gas is introduced from the gas supply source to the cooking utensil or inflow of the gas is blocked; and
a control unit electrically connected with the shutoff unit to open and close the shutoff unit under a predetermined condition.

2. The IoT-based gas safety shutoff system of claim 1, further comprising:
a time setting unit which is connected to the control unit and closes the shutoff unit when a predetermined time elapses from an operation time of the cooking utensil.

3. The IoT-based gas safety shutoff system of claim 1, further comprising:
a detecting unit which is connected to the control unit, and detects environment information corresponding to the predetermined condition and transmits the detected environment information to the control unit.

4. The IoT-based gas safety shutoff system of claim 3, wherein the detecting unit includes a flow rate sensor which checks a flow of the gas introduced to the cooking utensil.

5. The IoT-based gas safety shutoff system of claim 4, wherein in the case where the shutoff valve is in an on state in an initial state in which the cooking utensil is not used, when a flow rate is sensed through the flow rate sensor in the state where the cooking utensil is in an off state by a user, the control unit turns off the shutoff valve.

6. The IoT-based gas safety shutoff system of claim 4, wherein in the case where the shutoff valve is in an off state in an initial state in which the cooking utensil is not used, when a predetermined time elapses in the state where the cooking utensil is operated by a user, the control unit turns off the shutoff valve again regardless of the sensing by the flow rate sensor.

7. The IoT-based gas safety shutoff system of claim 4, wherein the detecting unit includes a motion detecting sensor which detects presence/absence of movement of an object at one area of the cooking utensil and transmits a result of the detection to the control unit.

8. The IoT-based gas safety shutoff system of claim 7, wherein in the case where the shutoff valve is in an on state in an initial state where the cooking utensil is not used, when a movement is detected at one area of the cooking utensil when a flow rate is sensed at a termination time of the operation of the cooking utensil after the cooking utensil is operated and then a predetermined time elapses, the control unit maintains the shutoff valve in the on state for a predetermined time and then turns off the shutoff valve.

9. The IoT-based gas safety shutoff system of claim 7, wherein when a movement is not sensed for a first time from an operation time of the cooking utensil by monitoring the movement at the one area of the cooking utensil, the control unit changes a second time at which the operation of the cooking utensil is terminated by the time setting unit to the first time that is shorter than the second time.

10. The IoT-based gas safety shutoff system of claim 3, wherein the detecting unit includes a gas leakage detecting sensor which checks leakage of gas in a space in which the cooking utensil is placed.

11. The IoT-based gas safety shutoff system of claim 10, wherein when the leakage of the gas in the space in which the cooking utensil is placed is confirmed, the control unit turns off the shutoff valve regardless of the operation state or the non-operation state of the cooking utensil.

12. The IoT-based gas safety shutoff system of claim 3, wherein the detecting unit includes a vibration detecting sensor which detects vibration of the cooking utensil.

13. The IoT-based gas safety shutoff system of claim 12, wherein when a vibration value of the cooking utensil exceeds a predetermined value, the control unit turns off the shutoff valve regardless of the operation state or the non-operation state of the cooking utensil.

14. The IoT-based gas safety shutoff system of claim 3, wherein the detecting unit includes a smoke leakage detecting sensor which detects a fire in a space in which the cooking utensil is placed.

15. The IoT-based gas safety shutoff system of claim 14, wherein when the smoke is detected in the space in which the cooking utensil is placed, the control unit turns off the shutoff valve regardless of the operation state or the non-operation state of the cooking utensil.

16. The IoT-based gas safety shutoff system of claim 3, further comprising:
a communication unit connected to at least one of the shutoff unit, the control unit, and the detecting unit so as to transmit information of at least one of the shutoff unit, the control unit, and the detecting unit to the outside.

17. The IoT-based gas safety shutoff system of claim 16, wherein the communication unit is mounted to an external IoT router and is provided so that any one of the shutoff unit, the control unit, and the detecting unit interworks with an external device.

18. The IoT-based gas safety shutoff system of claim 17, wherein the communication unit is integrally provided with an IoT router so that an IoT external device is connected and interworks with at least one of the shutoff unit, the control unit, and the detecting unit.

19. The IoT-based gas safety shutoff system of claim 16, further comprising:
a warning unit configured to receive an alarm generation request generated from the control unit and generates an alarm.

20. The IoT-based gas safety shutoff system of claim 19, wherein the warning unit is connected with the communication unit, and generates the generated alarm as at least one of voice information and image information, and simultaneously generates olfactory information, and includes a fragrance generating module which sprays fragrance to a predetermined space for visual and hearing-impaired people.
